(19) United States
(12) Patent Application Publication
(10) Pub. No.: US 2019/0217669 A1
(43) Pub. Date: Jul. 18, 2019

(54) PNEUMATIC VEHICLE TYRE

(71) Applicant: Continental Reifen Deutschland GmbH, Hannover (DE)

(72) Inventors: Christian Weber, Garbsen (DE); Matthias Seng, Hannover (DE); Krishnakumar Raghu, Hannover (DE)

(73) Assignee: Continental Reifen Deutschland GmbH, Hannover (DE)

(21) Appl. No.: 16/334,389

(22) PCT Filed: Jun. 19, 2017
(86) PCT No.: PCT/EP2017/064884

§ 371 Date: Mar. 19, 2019

(30) Foreign Application Priority Data
Sep. 20, 2016 (DE) 10 2016 217 970.5

(51) Int. Cl. B60C 19/08; B60C 11/01; B60C 11/03; B60C 11/11; B60C 11/12

(52) U.S. Cl. CPC B60C 19/082; B60C 11/01; B60C 11/0304; B60C 2011/1213; B60C 11/11; B60C 11/1204; B60C 2011/0358; B60C 11/0306

(57) ABSTRACT

A pneumatic vehicle tire having a profiled tread (1) that consists of an electrically nonconductive rubber material and has a central tread region (3) and, at each of the shoulders, a profile block row (2) having transverse grooves (7) that extend at an angle (β) of 70° to 90° to the circumferential direction, wherein the shoulder-side profile blocks (8) have block corners (8′) toward the tread center, wherein the central tread region (3) is subdivided into a multiplicity of profile blocks (4) and is provided with grooves (5) that extend at angles (α) of at most 60° to the circumferential direction, wherein all of the profile blocks (4, 8) are each provided with a number of sipes (9, 9′), and wherein the tread (1) is passed through in the radial direction by at least one electrically conductive rubber strip (14) extending in the circumferential direction, said rubber strip (14) forming an electrically conductive passage between the substructure of the tire and the tread outer surface. The tread (1) is passed through, in at least one of the shoulder-side profile block rows (2), by an electrically conductive rubber strip (14) that is at a distance (a1) of at least 3.0 mm from the closest block corners (8′) of the shoulder-side profile blocks (8) or blocklike profile positives.

The invention relates to a pneumatic vehicle tire of radial type, having a profiled tread that consists of an electrically nonconductive rubber material and has a central tread region and, at each of the shoulders, a profile block row or blocklike profile positives having transverse grooves that extend at an angle of 70° to 90° to the circumferential direction, wherein the shoulder-side profile blocks or the blocklike profile positives have block corners toward the tread center, wherein the central tread region is subdivided into a multiplicity of profile blocks and/or blocklike profile positives and is provided with grooves that extend at angles of at most 60° to the circumferential direction, wherein all of the profile blocks and/or blocklike profile positives are each provided with a number of sipes, and wherein the tread is passed through in the radial direction by at least one electrically conductive rubber strip extending in the circumferential direction, said rubber strip forming an electrically conductive passage between the substructure of the tire and the tread outer surface.

A pneumatic vehicle tire having a tread with such profiling is known for example from EP 2 222 481 B1. As main grooves, the tread of that pneumatic vehicle tire has, in the central tread region, diagonal grooves that extend at an angle of at most 60° to the circumferential direction. At the shoulders, the tread has profile block rows provided with transverse grooves, wherein the transverse grooves extend at an angle of 70° to 90° to the circumferential direction. That known pneumatic vehicle tire is intended primarily to have a particularly good water drainage capacity.

Similar forms of profiling of treads for winter tires are known in other embodiments. If such treads are produced from electrically nonconductive rubber material, an electrically conductive rubber strip, known as a carbon center beam (CCB), is provided, which is positioned in the central tread region in order to ensure the requisite dissipation of the electrostatic charges that arise during driving in all driving situations.

The sipes and the grooves, extending at small angles to the circumferential direction, in the central tread region are formed, during the vulcanization of the green tire in a vulcanizing mold, by a multiplicity of sipe blades (sipes) and profile webs (grooves). This multiplicity of profile webs and sipe blades requires high withdrawal forces when the fully vulcanized tire is demolded from the vulcanizing mold. In particular, the sipe blade density in those regions of the vulcanizing mold that form the central tread region is much higher than in those regions that form the shoulder-side profile blocks. These high withdrawal forces are problematic in particular where the carbon center beam, consisting of a different rubber material than the rest of the tread, extends, such that, during demolding, in the region of the carbon center beam, cracks can arise in the groove bottoms and/or block breakouts and cracking can arise at the profile blocks.

Therefore, the invention is based on the object, in the case of a pneumatic vehicle tire of the tyre mentioned at the beginning, of preventing the occurrence of such damage to the tread during demolding from the vulcanizing mold.

The stated object is achieved according to the invention in that the tread is passed through, in at least one of the shoulder-side profile block rows or blocklike profile positives, by an electrically conductive rubber strip that is at a distance of at least 3.0 mm from the closest block corners of the shoulder-side profile blocks or blocklike profile positives.

Therefore, according to the invention, in at least one of the two shoulder-side profile block rows, a respective electrically conductive rubber strip extends at a minimum distance of 3.0 mm from the closest block corners of the profile blocks. Since, furthermore, the transverse grooves extending in the shoulder-side profile block rows are at a greater inclination to the circumferential direction compared with the grooves extending in the central tread region, the forces required for demolding the pneumatic vehicle tire from the vulcanizing mold are much lower in the region of the profile webs that mold the shoulder-side transverse grooves than in the region of the profile webs that mold the grooves, inclined with respect to the circumferential direction, in the central tread region. Therefore, no or scarcely any cracking arises in the electrically conductive rubber strips positioned at the shoulders.

Particular preference is given to an embodiment of the invention in which the two shoulder-side profile block rows or shoulder-side blocklike profile positives are passed through by an electrically conductive rubber strip that is at a distance of at least 3.0 mm from the closest block corners of the shoulder-side profile blocks or blocklike profile positives. Even in the case of a greater wheel camber, reliable dissipation is thus ensured under all driving conditions, since at least one of the carbon shoulder beams is always in contact with the road. In addition, the two carbon shoulder beams give the tread a symmetrical appearance, and so the impression that the carbon shoulder beams could be defects is avoided.

Particularly favorable demolding forces can be achieved according to a preferred embodiment variant of the invention when the distance of the electrically conductive rubber strip from the closest block corners of the shoulder-side profile blocks or blocklike profile positives is at least 10.0 mm. It is also advantageous in this connection when, according to a further preferred embodiment variant, the electrically conductive rubber strip extends in the region of the middle of the shoulder-side profile block row or blocklike profile positives.

In a further preferred embodiment variant, the shoulder-side profile block rows or blocklike profile positives each have, within the ground contact patch, a width in the axial direction of 10% to 30%, in particular of at most 20%, of the ground contact patch width.

In a further embodiment variant that is particularly preferred with regard to winter driving properties, the central tread region is subdivided into profile blocks and/or blocklike profile positives by diagonal grooves and short grooves extending therebetween.

The forces that arise during the demolding of the fully vulcanized pneumatic vehicle tire from the vulcanizing mold are particularly low when the transverse grooves extend at an angle of at most 85° to the circumferential direction in shoulder-side profile block rows or blocklike profile positives.

As already mentioned, the electrically conductive rubber strips form an electrically conductive passage between the substructure of the tire and the tread outer surface. In a preferred embodiment variant, the pneumatic vehicle tire has a belt assembly with belt plies having an electrically conductive rubber coating, wherein the rubber strips come into contact with the electrically conductive rubber coating of the radially outermost belt ply. According to a further preferred embodiment variant, the pneumatic vehicle tire has a belt bandage having an electrically conductive rubber coating, wherein the rubber strips come into contact with the electrically conductive rubber coating of the belt bandage.

Further features, advantages and details of the invention will now be described in more detail with reference to the drawing, which schematically shows an exemplary embodiment of the invention. In the drawing:

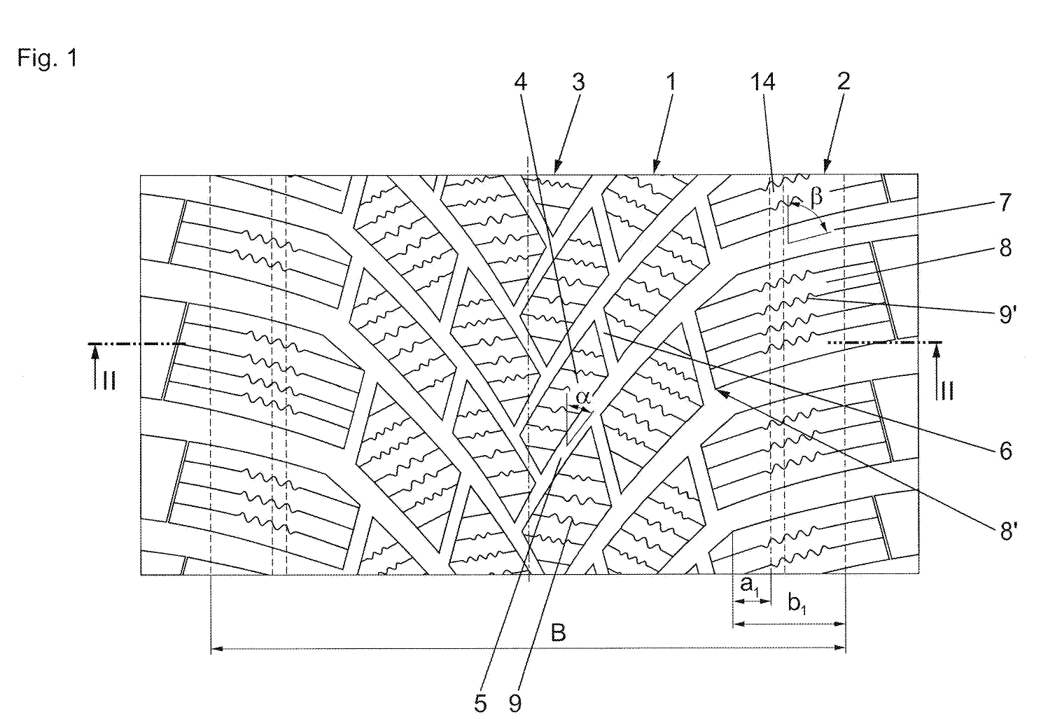

FIG. 1 shows a partial developed view of a tread of a pneumatic vehicle tire in plan view, and

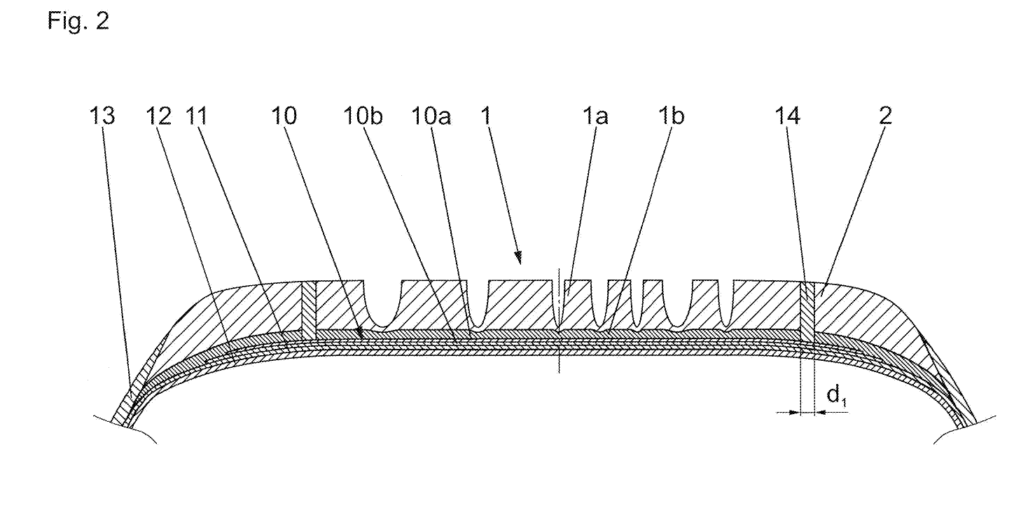

FIG. 2 shows a schematic and simplified cross section through a pneumatic vehicle tire having the tread shown in FIG. 1 in the region of the tread and of the belt assembly, in section along the line II-II in FIG. 1.

Pneumatic vehicle tires embodied in accordance with the invention are in particular winter tires of radial type for passenger cars, vans or light trucks. In the following text, the invention is explained by way of example on the basis of a winter tire provided for a passenger car.

The tread 1 shown in FIG. 1 is embodied in a directional manner and has a ground contact patch width B that corresponds to the width of the statically determined footprint as per the E.T.R.T.O. Standard (load at 70% of the load-bearing capacity at an internal pressure of 2.5 bar, internal pressure 85% of 2.5 bar). The tread 1 has two shoulder-side profile block rows 2 and, therebetween, a central tread region 3 structured with a multiplicity of profile blocks 4.

In the embodiment variant shown, the central tread region 3 is provided with diagonal grooves 5 and with short grooves 6 extending between diagonal grooves 5 that are adjacent in the circumferential direction, wherein the diagonal grooves 5 together with the short grooves 6 delimit the profile blocks 4. The diagonal grooves 5 extend at an angle α of 30° to 60°, in particular up to 45°, to the circumferential direction. In the exemplary embodiment shown, the diagonal grooves 5 extend in a V-shaped manner to one another, such that the central tread region 3 has an “arrowed” profile. A pneumatic vehicle tire having the tread 1 shown in FIG. 1 is mounted on the vehicle such that the tread-inner-side ends of the diagonal grooves 5 enter the ground contact patch first when the pneumatic vehicle tire rolls when driven forward. The short grooves 6 extend preferably at an acute angle of about 10° to the tire circumferential direction, wherein, in the exemplary embodiment shown, in each tread half, in each case two short grooves 6 extend between diagonal grooves 5 that are adjacent in the circumferential direction.

The shoulder-side profile block rows 2 have shoulder-side profile blocks 8 separated from one another by transverse grooves 7, wherein the transverse grooves 7 extend in continuation of the diagonal grooves 5, and so the profile blocks 8 are each delimited on the tread inner side by a short groove 6. The transverse grooves 7 extend beyond the ground contact patch and extend, in each tread half, parallel to one another and to the circumferential direction in each case at an angle β of 70° to 90°, in particular of at most 85°.

As a result of the illustrated and described arrangement of the diagonal grooves 5, of the short grooves 6 and of the transverse grooves 7, each shoulder-side profile block 8 has three block corners 8′ toward the tread center. Within the ground contact patch width B, the shoulder-side profile blocks 8 each have a width b₁ in the axial direction of 10% to 30%, in particular of at most 20%, of the ground contact patch width B, wherein the width b₁ is determined between the block corner 8′, located outermost on the tread, of the profile blocks 8 and the tread edge (edge of the ground contact patch).

The profile blocks 4 in the central tread region 3 and the shoulder-side profile blocks 8 are each provided with a number of sipes 9, 9′, which each have a width of 0.4 mm to 0.8 mm.

In the profile blocks 4, in each case five to seven sipes 9 that extend substantially in an axial direction are provided, which extend partially in a wavy manner locally in plan view.

Formed in the shoulder-side profile blocks 8 are two to four sipes 9′, which each have a wavy portion in plan view.

In FIG. 2, of the usual components of the pneumatic vehicle tire, the tread 1, a two-ply belt assembly 10, portions of a carcass insert 11, and an airtight inner layer 12, and the radially outer end regions of sidewalls 13 are illustrated. The carcass insert 11, the inner layer 12, the sidewalls 13, and the bead regions (not shown) can be embodied in a manner known per se.

The two belt plies 10a, 10b of the belt assembly 10 each consist of reinforcements that extend substantially parallel to one another and consist in particular of steel cord, said reinforcements being embedded in electrically conductive rubber material, the belt rubber coating. An electrically conductive rubber material is understood as being one that has a specific electrical resistance ≤10⁸ Ohm·cm. Radially outside the second belt ply 10b, a belt bandage made of textile reinforcements embedded in electrically conductive rubber material can be provided.

In the embodiment variant shown, the tread 1 has a two-layer construction in a radial direction and has a tread cap 1a containing the profiling and a tread base 1b that extends radially on the inside of the tread cap 1a, said tread base 1b extending across the entire width of the tread cap 1a. The tread cap 1a and the tread base 1b each consist of electrically nonconductive rubber material. The tread cap 1a, the tread base 1b and the rubber coating of the belt plies 10a, 10b and of the belt bandage are each preferably manufactured from a silica-containing rubber compound. The tread 1 can also be an electrically nonconductive one-piece tread embodied integrally in a radial direction.

In at least one of the shoulder-side profile block rows 2, and in both in the embodiment illustrated, there extends an electrically conductive rubber strip 14 that extends around the entire tread circumference, passes through the respective profile block row 2 in a radial direction, and has a thickness d₁ of 0.3 mm to 3.0 mm, preferably of 0.5 mm to 2.0 mm.

The rubber strips 14 come into contact, radially on the inside of the tread 1 or of the tread base 1b, with the electrically conductive rubber coating of the radially outer belt ply 10a or of the belt bandage. In the preferred embodiment variant shown, the rubber strips 14 are each positioned in the central region of the shoulder-side profile block rows 2. At the tread outer surface, the rubber strips 14 are at a distance a₁ (FIG. 1) of at least 3.0 mm, in particular of at least 10.0 mm, from the closest block corners 8′ of the profile blocks 8 in the axial direction. In a further embodiment that is not illustrated separately, a second rubber strip can be present in each case outside the illustrated rubber strips.

The invention is not limited to the exemplary embodiment described. In particular, the profiling of the central tread region 3 can be embodied differently than the variant shown in FIG. 1, wherein the central tread region 3 is subdivided by grooves, which extend at angles of at most 60° to the circumferential direction, into a multiplicity of profile blocks or blocklike profile positives, and wherein all of the profile blocks or blocklike profile positives are each provided with a number of sipes. Rather than shoulder-side block rows, profile positives provided with transverse grooves extending in a blind-groove-like manner and configured in a blocklike manner in this way can be provided.

### LIST OF REFERENCE SIGNS

1 . . . Tread
1a . . . Tread cap
1b . . . Tread base
2 . . . Shoulder-side profile block row
3 . . . Central tread region
4 . . . Profile block
5 . . . Diagonal groove
6 . . . Short groove
7 . . . Transverse groove
8 . . . Profile block
8′ . . . Block corner
9, 9′ . . . Sipe
10 . . . Belt assembly
10a, 10b . . . Belt ply
11 . . . Carcass insert
12 . . . Inner layer
13 . . . Sidewall
14 . . . Rubber strip
a₁ . . . Distance
B . . . Ground contact patch width
b₁ . . . Width
d₁ . . . Thickness
α, β . . . Angle

1-9. (canceled)

10. A pneumatic vehicle tire of radial type, having a profiled tread that comprises an electrically nonconductive rubber material, a central tread region and shoulders, wherein at each of the shoulders includes a profile block row having transverse grooves that extend at an angle (β) of 70° to 90° to a circumferential direction of the vehicle tire, wherein profile blocks comprised in the profile block row have block corners toward a center of the tread, wherein the central tread region is subdivided into a multiplicity of central profile blocks which are provided with grooves that extend at angles (α) of at most 60° to the circumferential direction of the vehicle tire, wherein the profile blocks and the central profile blocks are each provided with a number of sipes, and wherein the tread is passed through in the radial direction by at least one electrically conductive rubber strip extending in the circumferential direction of the vehicle tire, said at least one electrically conductive rubber strip forming an electrically conductive passage between the substructure of the tire and outer surface of the tread; and,
wherein the tread is passed through, in at least one of the profile block rows, by the at least one electrically conductive rubber strip that is at a distance (a1) of at least 3.0 mm from the closest block corners of the profile blocks.

11. The pneumatic vehicle tire as claimed in claim 10, wherein the profile block rows are passed through by the at least one electrically conductive rubber strip that is at a distance (a1) of at least 3.0 mm from the closest block corners of the profile blocks.

12. The pneumatic vehicle tire as claimed in claim 10, wherein the distance (a1) of the at least one electrically conductive rubber strip from closest block corners of the profile blocks is at least 10.0 mm.

13. The pneumatic vehicle tire as claimed in claim 10, wherein the at least one electrically conductive rubber strip extends in the region of a middle of the profile block row.

14. The pneumatic vehicle tire as claimed in claim 10, wherein the profile block rows each have, within a ground contact patch, a width (b1) in the axial direction of 10% to 30% of an overall ground contact patch width (B).

15. The pneumatic vehicle tire as claimed in claim 10, wherein grooves in the central tread region are diagonal grooves, which, together with short grooves extending therebetween, bring about a subdivision into the central profile blocks.

16. The pneumatic vehicle tire as claimed in claim 10, wherein the transverse grooves extend at an angle (β) of at most 85° to the circumferential direction of the vehicle tire in the profile block rows.

17. The pneumatic vehicle tire as claimed in claim 10, wherein the pneumatic vehicle tire has a belt assembly with belt plies having an electrically conductive rubber coating, and wherein the at least one electrically conductive rubber strip is in contact with the electrically conductive rubber coating of a radially outermost belt ply.

18. The pneumatic vehicle tire as claimed in claim 10, wherein the pneumatic vehicle tire has a belt bandage having an electrically conductive rubber coating, wherein the at least one electrically conductive rubber strip is in contact with the electrically conductive rubber coating of the belt bandage.

19. The pneumatic vehicle tire as claimed in claim 10, wherein the central tread region is devoid of a carbon center beam (CCB).

20. A pneumatic vehicle tire of radial type, having a profiled tread that comprises an electrically nonconductive rubber material, a central tread region and shoulders, wherein at each of the shoulders includes blocklike profile positives having transverse grooves that extend at an angle (β) of 70° to 90° to a circumferential direction of the vehicle tire, wherein profile blocks comprised in the blocklike profile positives have block corners toward a center of the tread, wherein the central tread region is subdivided into a multiplicity of central profile blocks which are provided with grooves that extend at angles (α) of at most 60° to the circumferential direction of the vehicle tire, wherein the profile blocks and the central profile blocks are each provided with a number of sipes, and wherein the tread is passed through in the radial direction by at least one electrically conductive rubber strip extending in the circumferential direction of the vehicle tire, said at least one electrically conductive rubber strip forming an electrically conductive passage between the substructure of the tire and outer surface of the tread; and,
wherein the tread is passed through, in at least one of the blocklike profile positives, by the at least one electrically conductive rubber strip that is at a distance (a1) of at least 3.0 mm from the closest block corners of the profile blocks.

21. The pneumatic vehicle tire as claimed in claim 20, wherein the blocklike profile positives are passed through by the at least one electrically conductive rubber strip that is at a distance (a1) of at least 3.0 mm from the closest block corners of the profile blocks.

22. The pneumatic vehicle tire as claimed in claim 20, wherein the distance (a1) of the at least one electrically conductive rubber strip from closest block corners of the profile blocks is at least 10.0 mm.

23. The pneumatic vehicle tire as claimed in claim 20, wherein the at least one electrically conductive rubber strip extends in the region of a middle of the blocklike profile positives.

24. The pneumatic vehicle tire as claimed in claim 20, wherein the blocklike profile positives each have, within a ground contact patch, a width (b1) in the axial direction of 10% to 30% of an overall ground contact patch width (B).

25. The pneumatic vehicle tire as claimed in claim 20, wherein grooves in the central tread region are diagonal grooves, which, together with short grooves extending therebetween, bring about a subdivision into the central profile blocks.

26. The pneumatic vehicle tire as claimed in claim 20, wherein the transverse grooves extend at an angle (β) of at most 85° to the circumferential direction of the vehicle tire in the blocklike profile positives.

27. The pneumatic vehicle tire as claimed in claim 20, wherein the pneumatic vehicle tire has a belt assembly with belt plies having an electrically conductive rubber coating, and wherein the at least one electrically conductive rubber strip is in contact with the electrically conductive rubber coating of a radially outermost belt ply.

28. The pneumatic vehicle tire as claimed in claim 20, wherein the pneumatic vehicle tire has a belt bandage having an electrically conductive rubber coating, wherein the at least one electrically conductive rubber strip is in contact with the electrically conductive rubber coating of the belt bandage.

29. The pneumatic vehicle tire as claimed in claim 20, wherein the central tread region is devoid of a carbon center beam (CCB).
